(19) United States
(12) Patent Application Publication
(10) Pub. No.: US 2007/0296826 A1
(43) Pub. Date: Dec. 27, 2007

(54) PICTURE PROCESSING APPARATUS, IMAGING APPARATUS AND METHOD OF THE SAME

(75) Inventor: Masashige KIMURA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/764,401

(22) Filed: Jun. 18, 2007

(30) Foreign Application Priority Data
Jun. 22, 2006 (JP) 2006-172974

(51) Int. Cl. H04N 5/228

(52) U.S. Cl. 348/222.1

(57) ABSTRACT

An imaging apparatus which images pictures using a solid-state imaging device includes a picture conversion unit converting pictures imaged at a high-speed screen rate by the solid-state imaging device into a picture in which n-pieces (“n” is an integer of 2 or more) of continuous imaged pictures are arranged in one screen and outputting the converted picture at a low-speed screen rate which is 1/n of the high-speed screen rate, a signal processing unit performing predetermined picture-quality compensation processing to the picture from the picture conversion unit, a display picture cutting unit cutting one of n-pieces of imaged pictures from pictures processed by the signal processing unit and outputting the picture at the low-speed screen rate, and a display processing unit generating picture signals for displaying the picture outputted from the display picture cutting unit at a display device.

### CROSS REFERENCE TO RELATED APPLICATIONS

The present invention contains subject matter related to Japanese Patent Application JP 2006-172974 filed in the Japanese Patent Office on Jun. 22, 2006, the entire contents of which being incorporated herein by reference.

### BACKGROUND OF THE INVENTION

1. Field of the Invention

The invention relates to a picture processing apparatus which processes picture signals, an imaging apparatus which images pictures by using a solid-state imaging device and a processing method in these apparatuses, and particularly, relates to the picture processing apparatus, the imaging apparatus and the method capable of processing picture signals having a screen rate which is higher than the standard.

2. Description of the Related Art

In recent years, as ability of an imaging device and a signal processing technology make progress, a consumer-digital video camera is realized, which is capable of taking and recording pictures of a HDTV (High Definition Television) standard in which resolution is increased as compared with an existing NTSC (National Television Standards Committee) standard.

In an imaging device used in the imaging apparatus such as a digital video camera or a digital still camera, there are many apparatuses capable of outputting imaged pictures at a cycle shorter than a display cycle of the present TV broadcast standard. Therefore, an imaging apparatus in which such high-speed imaging function is mounted has been devised. For example, an imaging apparatus has been devised, in which a slow playback is made possible by playing back and displaying video data which has been imaged and recorded at a screen rate higher than the standard by utilizing such imaging device at the standard screen rate.

A data transmission amount when transmitting data of imaged pictures inside the imaging apparatus is in proportion with spatial resolution (picture size)×time resolution (screen rate). Therefore, when imaging pictures by making the screen rate higher, the data transmission amount in the imaging apparatus increases, and it becomes necessary to improve ability of a processing circuit for processing the picture data. Specifically, in accordance with high speed of the screen rate, it is necessary to increase ability of a signal processing circuit performing processing of picture quality compensation, imaging operation control and the like based on the picture data obtained by imaging pictures, a compression and encoding circuit of the picture data, and a recording circuit for recording the compressed and encoded picture data in a magnetic tape and the like and a display circuit for displaying pictures during imaging at a monitor for confirming field angles and the like. Consequently, there are problems that manufacturing costs, circuit size and power consumption increase.

Concerning the above, a method has been devised, in which, after data of pictures imaged at the high-speed rate is temporarily stored in an internal memory which is accessible at high-speed, the picture data is read out from the internal memory at a standard rate, compressed and encoded to be recorded in a recording medium. According to the method, as a signal system from reading out the data from the internal memory until recording it in the recording medium, an existing circuit corresponding to the standard rate can be used as it is, therefore, manufacturing/development costs can be suppressed. The recorded pictures are played in a slow mode by playing back by an existing playback device corresponding to the standard rate, therefore, compatibility of recorded data can be maintained.

As a video camera of related arts which does not have a function of displaying pictures during imaging at a monitor (for example, a video camera recording analog picture signals), there was one in which pictures having ¼ size of the standard picture size are imaged at four-times speed, and four ¼ size pictures are incorporated in a picture of the standard rate to be recorded at the standard rate (for example, refer to JP-A-9-107516 and JP-A-8-88833 (Patent Documents 1 and 2)).

### SUMMARY OF THE INVENTION

In a consumer imaging apparatus such as a digital video camera, competition between manufacturers heats up, and demands for further high-picture quality, miniaturization and high-function increase. In view of the above, a high-speed imaging function which performs imaging at a rate higher than the normal imaging rate can be an important additional function when making the imaging apparatus high in function and increase its commercial value.

However, as described above, it is necessary to improve processing ability inside the apparatus in order to realize high-speed imaging function, and increase of manufacturing costs and enlargement of the apparatus caused by the improvement makes a problem when mounted on the consumer imaging apparatus. That is, it is desired that a high-speed imaging function and a function of allowing pictures imaged at the high-speed rate to display at a slow mode are realized with minimum change in existing circuit configuration. Moreover, concerning the recorded data, it is desired that playback compatibility in other playback devices is maintained as much as possible.

In the above-described method in which, after data of pictures imaged at the high-speed rate is temporarily stored in the internal memory, the data is read out at the standard rate and recorded, in the case of playing back the recorded pictures by the existing playback device, only the slow playback can be performed, and it is basically difficult to perform one-time speed playback corresponding to the case of imageing pictures at the normal rate. Accordingly, it was difficult to record audio and pictures at the same time or to play back the audio normally by the one-time speed playback. And further, there was a problem in the method that time during which pictures can be imaged at the high-speed rate depends on capacity of the internal memory.

It is desirable to provide an inexpensive picture processing apparatus and a picture processing method capable of processing picture signals inputted at a screen rate higher than the standard.

It is also desirable to provide an inexpensive imaging apparatus and an imaging method capable of processing picture signals imaged at a screen rate higher than the standard.

According to an embodiment of the invention, there is provided a picture processing apparatus which processes picture signals including a picture conversion unit converting pictures inputted at a high-speed screen rate into a picture in which n-pieces (“n” is an integer of 2 or more) of continuous inputted pictures are arranged in one screen and outputting the converted picture at a low-speed screen rate which is 1/n of the high-speed screen rate, a display picture cutting unit cutting one of n-pieces of inputted pictures from the picture outputted from the picture conversion unit and outputting the picture at the low-speed screen rate, and a display processing unit generating picture signals for displaying the picture outputted from the display picture cutting unit at a display device.

In such picture processing apparatus, when pictures are inputted at the high-speed screen rate, the pictures are converted into a picture in which continuous n-pieces of inputted pictures are arranged in one screen by the picture conversion unit, and the picture is outputted at the low-speed screen rate which is 1/n of the high-speed screen rate. In the display picture cutting unit, one of the n-pieces of pictures is cut from the converted picture, and the picture is outputted to the display processing unit at the low-speed screen rate. In the display processing unit, picture signals for displaying the cut inputted picture at the display device at the low-speed screen rate are generated.

According to an embodiment of the invention, there is provided a imaging apparatus which images pictures using a solid-state imaging device including a picture conversion unit converting pictures imaged at a high-speed screen rate by the solid-state imaging device into a picture in which n-pieces (“n” is an integer of 2 or more) of continuous imaged pictures are arranged in one screen and outputting the converted picture at a low-speed screen rate which is 1/n of the high-speed screen rate, a signal processing unit performing predetermined picture-quality compensation processing to the picture from the picture conversion unit, a display picture cutting unit cutting one of n-pieces of imaged pictures from pictures processed by the signal processing unit and outputting the picture at the low-speed screen rate, and a display processing unit generating picture signals for displaying the picture outputted from the display picture cutting unit at a display device.

In the above imaging apparatus, when pictures are imaged at the high-speed screen rate by the solid-state imaging device, the pictures are converted into a picture in which n-pieces of continuous imaged pictures are arranged in one screen by the picture conversion unit, and the picture is outputted at the low-speed screen rate which is 1/n of the high-speed screen rate. After the converted picture receives the predetermined picture-quality compensation processing at the signal processing unit, the picture is supplied to the display picture cutting unit, and one of n-pieces of imaged pictures is cut from the picture and outputted to the display processing unit at the low-speed screen rate. In the display processing unit, picture signals for displaying the cut imaged picture at the display device at the low-speed screen rate are generated, as a result, pictures during imaged can be visually confirmed at the display device.

In the picture processing apparatus according to an embodiment of the invention, an existing transmission system which can transmit a picture having resolution capable of arranging n-pieces of inputted pictures at a slow-speed screen rate is used, thereby transmitting input pictures of a high-speed screen rate which is n-times the screen rate without losing picture information. In addition, in the display processing unit, since the inputted picture at the high-speed screen rate is supplied intermittently and processed at the low-speed screen rate, it is not necessary to make the display processing unit correspond to the processing at the high-speed screen rate. Therefore, a picture processing apparatus which can process picture signals of high-speed screen rate is realized, in which manufacturing costs are suppressed because the signal transmission system for the existing low-speed screen rate is not drastically changed.

In the imaging apparatus according to an embodiment of the invention, an existing transmission system which can transmit a picture having resolution capable of arranging n-pieces of imaged pictures at a slow-speed screen rate is used, thereby processing imaged pictures of a high-speed screen rate which is n-times the screen rate. In addition, in the display processing unit, since the imaged picture at the high-speed screen rate is supplied intermittently and processed at the low-speed screen rate, pictures during imaging can be visually confirmed at the display device without making the display processing unit correspond to the processing at the high-speed screen rate. Therefore, a picture processing apparatus which can process picture signals imaged at the high-speed screen rate is realized, in which manufacturing costs are suppressed.

### BRIEF DESCRIPTION OF THE DRAWINGS

FIG. 1 is a block diagram showing a configuration of an imaging apparatus according to a first embodiment of the invention;

FIG. 2 is the view for explaining the size of pictures which can be processed in the imaging apparatus;

FIG. 3 is a diagram for explaining the flow of signals at the time of recording pictures in the first embodiment;

FIG. 4 is a diagram showing the flow of signals in a slow playback mode in the first embodiment;

FIG. 5 is a diagram showing the flow of signals at the normal playback mode in the first embodiment;

FIG. 6 is a timing chart schematically showing operations at the time of recording/playing back of pictures and audio in the first embodiment;

FIG. 7 is a diagram for explaining the flow of signals at the time of recording pictures in the second embodiment;

FIG. 8 is a diagram showing the flow of signals in a slow playback mode in the second embodiment;

FIG. 9 is a diagram showing the flow of signals at the normal playback mode in the second embodiment; and

FIG. 10 is a timing chart schematically showing operations at the time of recording/playing back of pictures and audio in the second embodiment.

### DESCRIPTION OF THE PREFERRED EMBODIMENTS

Hereinafter, embodiments of the invention will be explained in details with respect to the drawing.

### First Embodiment

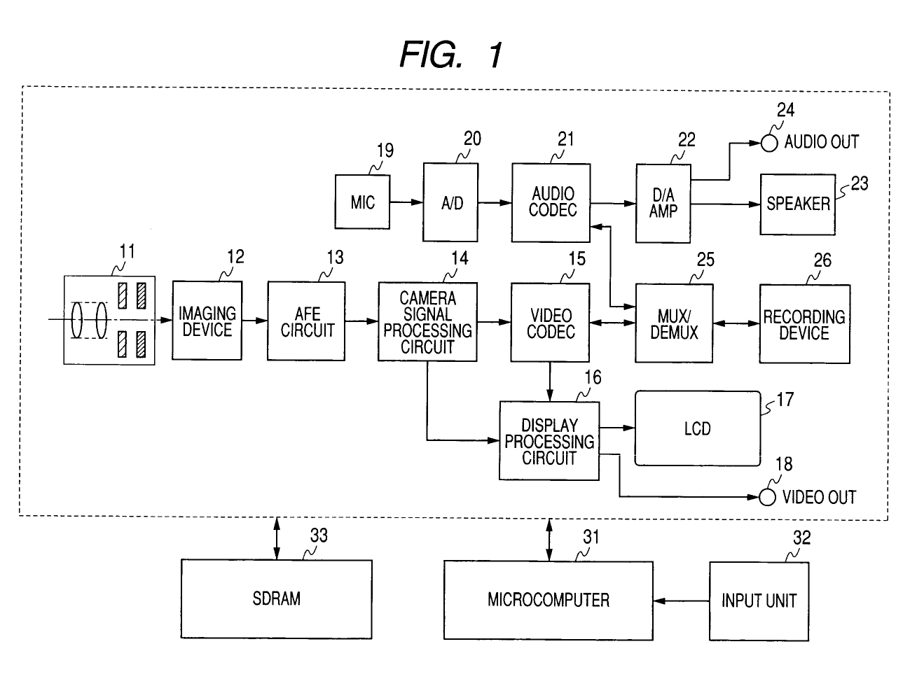

FIG. 1 is a block diagram showing a configuration of an imaging apparatus according to a first embodiment of the invention.

An imaging apparatus shown in FIG. 1 is a so-called a digital video camera which images moving pictures and recording imaged pictures in a recording medium as digital data.

The imaging apparatus includes an optical block 11, an imaging device 12, an analog front end (AFE) circuit 13, a camera signal processing circuit 14, a video CODEC (Coder/Decoder) 15, a display processing circuit 16, a LCD (Liquid Crystal Display) 17, a video output terminal 18, a microphone 19, an A/D converter 20, an audio CODEC 21, a D/A (Digital/Analog) converter amp 22, a speaker 23, an audio output terminal 24, MUX/DEMUX (Multiplexer/Demultiplexer) 25, a recording device 26, microcomputer 31, an input unit 32, and a SDRAM (Synchronous Dynamic Random Access Memory) 33.

The optical block 11 includes lenses for collecting light from a subject to the imaging device 12, a drive mechanism for performing focusing or zooming by moving the lens, a shutter mechanism, an iris mechanism and the like.

The imaging device 12 is a solid-state imaging device such as a CCD (Charge Coupled Devices) and a CMOS (Complementary Metal-Oxide Semiconductor) image sensor, which converts light collected by the optical block 11 into electric signals. As described later, the imaging device 12 is capable of outputting imaging picture signals not only at a standard screen rate (60 fields/second) but also at a higher screen rate (four times the standard in this case).

The AFE circuit 13 performs sample-and-hold so as to keep S/N (Signal/Noise) ratio good with respect to picture signals outputted from the imaging device 12 by CDS (Correlated Double Sampling) processing under control of the microcomputer 31, and further, controls gain by AGC (Auto Gain Control) processing to output digital-converted picture data. As described later, the AFE circuit 13 also has a function of performs resolution conversion of picture data imaged by the imaging device 12 at a high-speed screen rate and converting the data into HD picture data of a standard screen rate.

The camera signal processing circuit 14 executes various demodulation processing based on picture data from the AFE circuit 13 and various signal compensation processing with respect to the picture data under control of the microcomputer 31. For example, demodulation processing for imaging operation adjustment such as AF (Auto Focus), AE (Auto Exposure) and demodulation processing for signal compensation processing in the camera signal processing circuit 14 are performed, and the demodulated values are notified to the microcomputer 31. In addition, signal compensation processing such as white balance adjustment is performed with respect to picture data from the AFE circuit 13, when receiving a control signal from the microcomputer 31 based on the notification result. As described later, the last stage of the camera signal processing circuit 14 has a function of cutting a part of a picture area from input picture data.

Under the control of the microcomputer 31, the video CODEC 15 compresses and encodes picture data outputted from the camera signal processing circuit 14 and supplies the data to the MUX/DEMUX 25 as a video ES (Elementary Stream). The video ES separated by the MUX/DEMUX 25 is decompressed and decoded. In the embodiment, the video CODEC 15 performs compressing and encoding/decompressing and decoding in accordance with MPEG (Moving Picture Experts Group) system.

The display processing circuit 16 converts picture data from the camera signal processing circuit 14 or picture data decompressed and decoded at the video CODEC 15 into signals for screen display. LCD 17 receives supply of picture signals from the display processing circuit 16 and displays pictures during taking or playback pictures of data recorded in the recording device 26. The video outputting terminal 18 outputs picture signals from the display processing circuit 16 to external devices. In addition, high resolution (namely, HD picture quality) pictures and low resolution (namely, SD picture quality) pictures can be outputted from the video output terminal 18.

The microphone 19 picks up audio signals. The A/D converter 20 converts the audio signals picked up by the microphone 19 into digital data at a predetermined sampling rate. The audio CODEC 21 encodes the digitalized audio data in accordance with, for example, a prescribed compressing and encoding system such as the MPEG system and supplies the data to the MUX/DEMUX 25 as an audio ES under control of the microcomputer 31. In addition, the audio ES separated by the MUX/DEMUX 25 is decompressed and decoded.

The D/A converter amp 22 converts the decompressed and decoded audio data into analog signals by the audio CODES 21. The converted audio signals are amplified and outputted to the speaker 23 to playback and output audio. The audio output terminal 24 outputs the analog audio signals from the D/A converter amp 22 to external devices.

The MUX/DEMUX 25 divides the video ES from the video CODEC 15 and the audio ES from the audio CODEC 21 into packets, and multiplexes these packets, thereby generating a PS (Program Stream) to be outputted to the recording device 26 under control of microcomputer 31. In addition, the video ES and the audio ES are separated from the PS read out from the recording device 26 to be respectively outputted to the video CODEC 15 and the audio CODEC 21.

The recording device 26 is a device for recording stream data (PS) of video/audio generated at the MUX/DEMUX 25, and for example, realized as a drive device of portable recording media such as a magnetic tape, an optical disk, or a HDD (Hard Disk Drive). It is also possible to read out the PS recorded in the recording device 26 and supplied to the MUX/DEMUX 25.

The microcomputer 31 includes CPU (Central Processing Unit), memories such as a ROM (Read Only Memory) and a RAM, and controls the imaging apparatus as a whole by executing programs stored in the memories. The input unit 32 outputs a control signal to the microcomputer 31 in accordance with operational input by the user with respect to a not-shown input device. The SDRAM 33 mainly stores data (picture data and the like) necessary during information processing in the imaging apparatus temporarily.

In the above imaging apparatus, when recording of picture/audio data is performed, data of imaged pictures processed in the camera signal processing circuit 14 is outputted to the display processing circuit 16, and pictures during imaging are displayed at the LCD 17 and data of imaged pictures are supplied also to the video CODEC 15, and compressing and encoding processing (encoding processing) is executed to generate a video ES. The audio CODEC 21 encodes the picked up audio data to generate an audio ES. The MUX/DEMUX 25 multiplies the generated video ES and the audio ES to generate a PS, and the PS is stored in the recording device 26 as a data file.

On the other hand, when the PS recorded in the recording device 26 is played back, the PS read out from the recording device 26 is separated by the MUX/DEMUX 25, and the separated video ES is decompressed and decoded by the video CODEC 15. The decoded picture data is supplied to the display processing circuit 16, thereby displaying playback pictures to the LCD 17. It is also possible to output playback picture signals from the video output terminal 18. In addition, the audio ES separated by the MUX/DEMUX 25 is decoded by the audio CODEC 21 and the decoded audio data is supplied to the D/A converter amp 22. Accordingly, audio is outputted from the speaker 23. It is also possible to output audio signals from the audio output terminal 24.

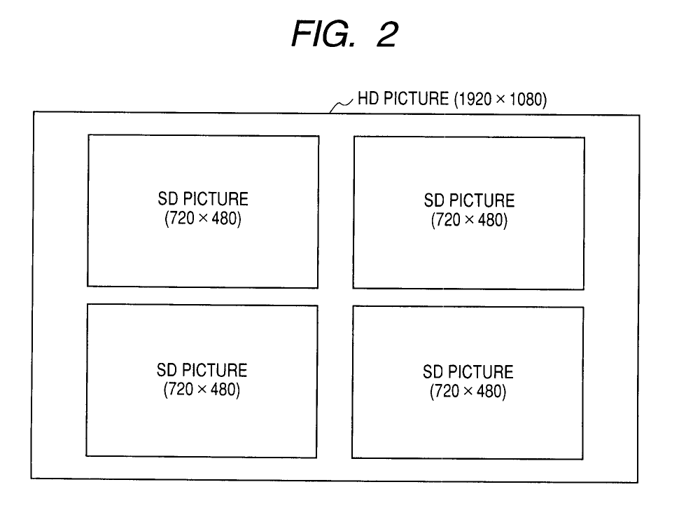

FIG. 2 is the view for explaining the size of pictures which can be processed in the imaging apparatus.

The imaging apparatus according to the embodiment of the invention is basically capable of handling both pictures of HD picture quality (HD pictures) and pictures of SD picture quality (SD pictures). That is, the apparatus is capable of transmit both data of the HD pictures and the SD pictures to a signal transmission system including the camera signal processing circuit 14, the video CODEC 15 and the like, and also capable of display pictures based on these data at the LCD 17 as well as recording these data in the recording device 26. In addition, the apparatus is capable of outputting picture signals of either picture quality from the video output terminal 18.

In the embodiment, an interlaced picture of 1920 pixels×1080 pixels which is one of standard picture formats of HD picture quality is applied as an example of the HD picture which can be recorded and outputted, and an interlaced picture of 720 pixels×480 pixels which is a standard picture format of a NTSC (National Television Standards Committee) system is applied as an example of the SD picture.

The principal internal circuits of the imaging apparatus include an ability of processing data of 1080i HD pictures. For example, the camera signal processing 14 and the video CODEC 15 can process inputted data of HD pictures at a speed of 60 field/second. As described above, the imaging device 12 of the imaging apparatus is capable of imaging and outputting pictures at higher screen rate than the standard screen rate (60 field/second).

In the internal circuits of the imaging apparatus, when the screen rate (namely, time resolution) is “n” times of the standard (in this case, “n” is an integer of 1 or more), spatial resolution is converted to 1/n of the standard picture, thereby allowing n-pieces of picture data after conversion to be processed by being incorporated in a standard picture and transmitted. In the embodiment, as shown in FIG. 2, a piece of HD picture has spatial resolution in which four pieces of SD pictures are arranged without particularly changing spatial arrangement of pixels in each SD picture. By utilizing this in the embodiment, pictures imaged at four-times the standard screen rate in the imaging device 12 are converted into the SD pictures, four-pieces of SD pictures are incorporated in a HD picture, and the HD picture is transmitted to the internal circuit. Accordingly, four-times high speed imaging is realized without particularly changing configuration of the principal internal circuit.

As described above, picture data is transmitted as a field unit both in the formats of the HD pictures and SD pictures used in the embodiment, however, in the following explanation, picture data to be transmitted will be explained as a frame unit. For example, the standard screen rate is represented as 30 fps (frame/second).

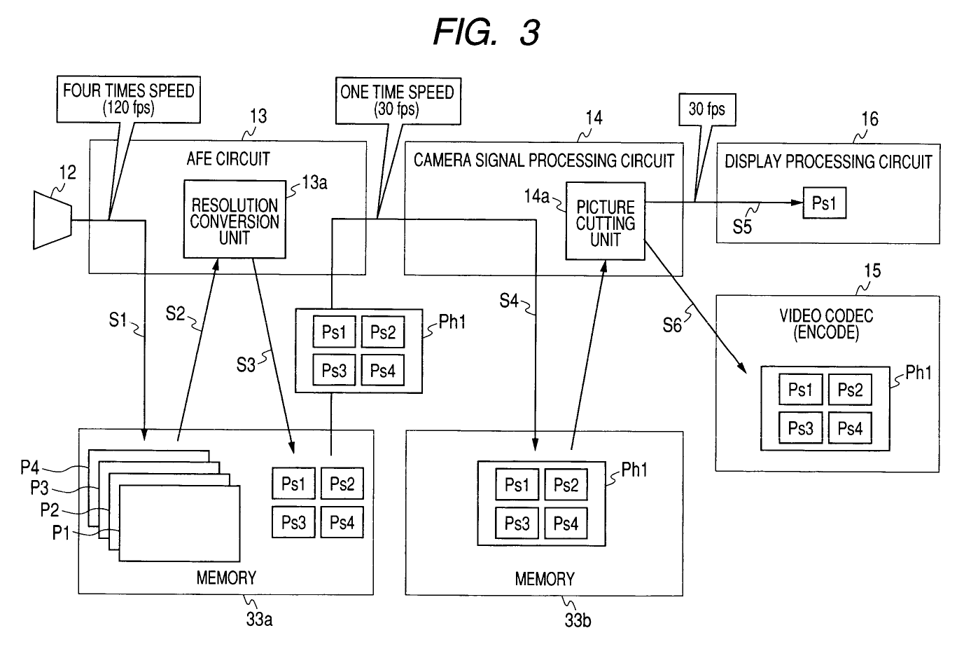

FIG. 3 is a diagram for explaining the flow of signals at the time of recording pictures in the first embodiment.

First, when pictures are imaged at a high-speed imaging mode, picture signals having prescribed resolution are outputted from the imaging device 12 at a screen rate (120 fps) which is four times the standard rate. The picture signals from the imaging device 12 are digitally converted at the AFE circuit 13 while maintaining the speed, and the converted picture data is temporarily stores in a memory region 33a in the SDRAM 33 (Step S1). In FIG. 3, four pieces of pictures which are sequentially imaged are represented by P1 to P4.

Next, the picture data stored in the memory 33a is read out by a resolution conversion unit 13a provided at the last stage of the AFE circuit 13 while maintaining four-times speed (Step S2). The resolution conversion unit 13a is a block having a function of converting resolution of the inputted picture data, which sequentially converts the picture data read out from the memory region 33a into picture data having the SD picture quality and stores the data in the memory region 33a again (Step S3). In FIG. 3, a state in which the pictures P1 to P4 which has been sequentially imaged are converted into SD pictures Ps1 to Ps4 respectively by the resolution conversion unit 13a is shown.

The resolution of pictures taken at the imaging device 12 in the high-speed imaging mode is not particularly limited, however, it is preferable that it is higher than the resolution of the SD picture in consideration of prevention of deterioration of picture quality at later stages.

The resolution conversion unit 13a, for example when recording HD pictures in a normal imaging mode, operates so as to convert pictures stored in the memory region 33a after imaging into the resolution of HD pictures and to store them in the memory region 33a. In this case, the converted HD pictures are processed from the memory region 33a by the camera signal processing circuit 14, then, encoded as the HD pictures of 30 fps by the video CODEC 15 to be stored in the recording device 26.

Next, picture data converted to the SD picture quality by the processing of Step S3 is sequentially read out from the memory region 33a to the AFE circuit 13 at the same speed as the standard speed. At this time, a piece of HD picture in which sequential four SD pictures are incorporated which is stored in the memory region 33a is read out, for example, under read-out address control from the microcomputer 31. In FIG. 3, a state in which the sequential SD pictures Ps1 to Ps4 stored in the memory region 33a are read out in a state being incorporated in a piece of HD picture Ph1 is shown.

Accordingly, the HD picture in which four SD pictures are incorporated is transmitted from the AFE circuit 13 to the camera signal processing circuit 14 by exactly the same procedure as imaging and recording of the normal HD picture, and after a prescribed processing of picture quality correction and the like are performed, the picture is temporarily stored in a memory region 33b in the SDRAM 33 (Step S4).

Next, the HD picture stored in the memory region 33b is read out to a picture cutting unit 14a provided at the last stage of the camera signal processing circuit 14 at the speed of 30 fps which is the same as the standard speed. The picture cutting unit 14a has a function of cutting a picture of a prescribed area from the inputted pictures and outputting the picture data. The picture cutting unit 14a cuts only the prescribed picture area in the four SD pictures in the imaging order (in this case, the head picture region) from the HD picture in the memory region 33b as a representative picture for displaying on the LCD 17, and the picture data is outputted to the display processing circuit 16 (Step S5). In FIG. 3, a state in which the head SD picture Ps1 is cut from the HD picture Ph1 as the representative picture is shown. In actual, the picture cutting unit 14a converts the data of the cut head SD picture into resolution corresponding to the LCD 17 and outputs it to the display processing circuit 16.

Accordingly, the LCD 17 received picture signals from the display processing circuit 16 sequentially displays only the head picture of the four pictures which have been continuously imaged. At this time, in the display processing circuit 16 and the LCD 17, picture signals are transmitted at ¼ speed of the speed at the time of imaging, namely, at 30 fps which is the same speed as the standard, therefore, the same operation as the normal imaging mode is executed.

On the other hand, when recording of the imaged picture in the recording device 26 is requested, the HD picture read out at the speed of 30 fps from the memory region 33b passes through the image cutting unit 14a and is supplied to the video CODEC 15, and encoded as the HD picture of 30 fps which is the same as the standard (Step S6). The encoded data of the HD picture is stored in the recording device 26 as a stream data (PS) after multiplexed with audio data, and picture data thus recorded in the recording device 26 can be played back and displayed by various playback devices corresponding to the same HD picture format as the HD picture in which four SD pictures are arranged such as the HD picture Phi in the drawing, as described later.

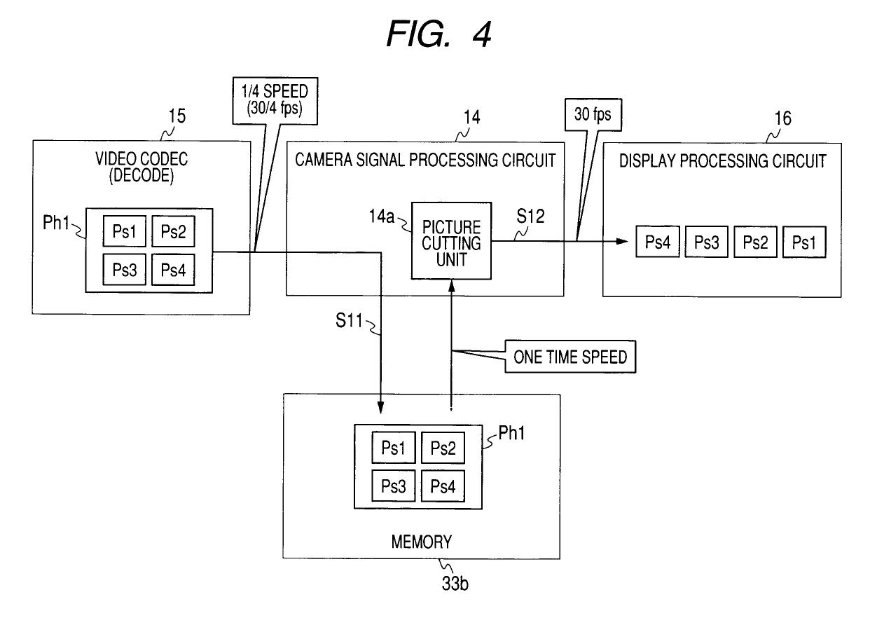

Next, operation at the time of playing back the HD picture data recorded as described above will be explained. As described below, the imaging apparatus includes a normal playback mode in which pictures are played back along the same passing of time as at the time of imaging, and a slow playback mode in which pictures are played back at ¼ of the speed. First, operation in the slow playback mode will be explained with reference to FIG. 4.

FIG. 4 is a diagram showing the flow of signals in the slow playback mode in the first embodiment. In the slow playback mode, the above-described HD picture data is read out from the recording device 26 at ¼ speed of the standard speed. The video CODEC 15 decodes picture data thus read out at the low speed and temporarily stores the decoded data in the memory region 33b at ¼ speed (step S11). It is noted that actual read-out speed and processing speed at the video CODEC 15 may be the same as the normal speed, and in this case, one frame is intermittently processed while processing four frames in the normal state.

Next, the HD picture stored in the memory region 33b is read out by the picture cutting unit 14a of the camera signal processing circuit 14, and data areas of the SD pictures incorporated in the HD picture are sequentially cut in the imaged order and supplied to the display processing circuit 16 at 30 fps which is the same speed as the standard (Step S12).

In this process, for example, data of the HD picture is read out from the memory region 33b to the picture cutting unit 14a at 30 fps. In this case, since the HD picture data is stored in the memory region 33b at ¼ speed of the standard, the picture cutting unit 14a sequentially reads out the same HD picture data four times. Then, the picture cutting unit 14a sequentially cuts a SD picture area at the upper left (corresponding to the SD picture Ps1 in the drawing), a SD picture area at the upper right (corresponding to the SD picture Ps2), a SD picture region at the lower left (corresponding to the SD picture Ps3 in the drawing), a SD picture area at the lower right (corresponding to the SD picture Ps4) from the respective read-in HD pictures, and outputs them to the display processing circuit 16.

According to the processing, pictures having the SD picture quality are sequentially displayed at 30 fps at the LCD 17 which receives picture signals from the display processing circuit 16. At this time, a switching cycle of the display screen is four times a cycle at the time of imaging, therefore, slow playback of ¼ speed can be realized. The data of SD pictures of 30 fps supplied from the picture cutting unit 14a to the display processing circuit 16 can be outputted from the video output terminal 18 to external devices as, for example, analog picture signals, which enables viewing of the slow playback pictures of the SD picture quality in the external devices. It is also preferable that the SD pictures of 30 fps are up-converted at, for example, the display processing circuit 16 and are outputted from the video output terminal 18 as signals of the HD picture.

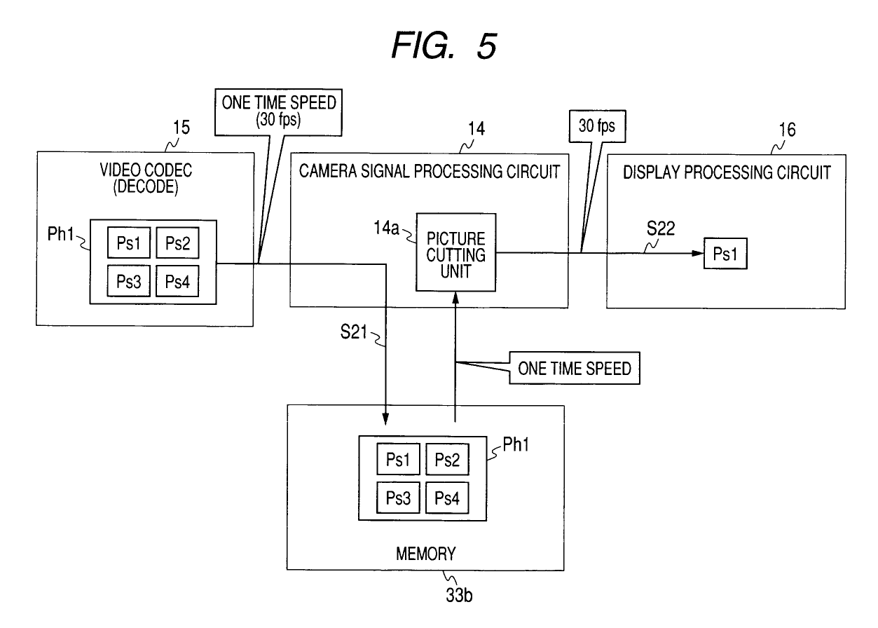

FIG. 5 is a diagram showing the flow of signals at the normal playback mode in the first embodiment.

In the normal playback mode, the data of HD pictures in which four SD pictures are incorporated as described above is read out from the recording device 26 at the standard speed, and decoded at the video CODEC 15. The decoded HD picture data is temporarily stored in the memory region 33b while maintaining the speed of 30 fps (Step S21).

Next, the HD picture stored in the memory region 33b is read out to the picture cutting unit 14a in the camera signal processing circuit 14 while maintaining the speed of 30 fps. Then, for example, a data area of the head SD picture (corresponding to the SD picture Ps1 in the drawing) is cut from the HD picture data by the picture cutting unit 14a as a representative picture for display, and supplied to the display processing circuit 16 at the speed of 30 fps (step S22). As a result, only a piece of four imaged pictures is intermittently displayed at the LCD 17 as the representative picture, however, the display cycle of the representative picture is along the passing of time when the pictures were imaged, therefore, the user can view the SD picture as playback pictures at the normal speed.

Also in the normal playback mode, similar to the case of the slow playback mode, the SD picture data of 30 fps supplied from the display processing circuit 16 may be outputted from the video output terminal 18, for example, as analog picture signals. It is also preferable that the SD picture is up-converted into the HD picture to output it from the video output terminal 18.

In the above processing, first, in the recording processing at the high-speed imaging mode explained in FIG. 3, though the pictures are imaged at four times speed of the standard screen rate, picture data thus imaged is processed as the HD picture of the standard screen rate after the camera signal processing circuit 14. Therefore, in the signal transmission system after the camera signal processing circuit 14 (including the camera signal processing circuit 14, the display processing circuit 16 and the video CODEC 15), existing circuits corresponding to processing of the HD picture can be utilized as they are without particularly increasing processing ability except the function of the picture cutting unit 14a.

According to the above recording processing procedure, continuous recording time of pictures imaged at the high speed imaging mode does not depend on, for example, capacity of a memory in which the pictures are temporally stored during signal transmission, and depends on only capacity of a recording device in which pictures are finally recorded.

Also in the processing in the normal playback mode explained in FIG. 5, the video CODEC 15 decodes the HD picture normally, and the display processing circuit 16 processes the SD picture normally, therefore, the existing signal transmission system including these circuits can be utilized as it is. And further, in the processing in the slow playback mode explained in FIG. 4, the display processing circuit 16 normally processes the SD pictures in the same way. Though the video CODEC 15 receives picture data at ¼ speed of the standard, the procedure in which picture data of only one frame is decoded intermittently with respect to four frames of the normal state is taken, thereby utilizing existing circuits almost as they are by changing control procedure.

The function of cutting pictures included in the picture cutting unit 14a is generally utilized by demodulation processing and the like, for example, in the camera signal processing circuit 14 from the past. Therefore, it seems unlikely that manufacturing costs increase or circuit scale drastically increases by providing the picture cutting unit 14a. According to the series of processing, picture data imaged at the higher screen rate than the standard speed can be recorded without changing the existing circuit configuration drastically, and the normal playback and the slow playback of the picture data can be also realized. Such function can be realized easily without causing the increase in manufacturing costs or the apparatus size.

In imaging apparatuses of related arts, there is one having a function of cutting part of imaging pictures to be zoomed-displayed at the LCD for confirming whether a subject is in focus at an intended point or not. In such apparatus type, the picture cutting function for zoom display can be diverted as the picture cutting unit 14a of the embodiment as it is.

The HD picture data recorded in the high-speed imaging mode will be general-purpose data complying with the standard HD picture format. That is, the HD picture data is one in which four almost the same SD pictures (to be precise, four pictures in which imaging timing is shifted by 1/120 second, respectively) are arrayed, however, it is certified that the data can be played back by other playback devices corresponding to the same HD picture format.

Since the picture data to be recorded becomes such general-purpose data, audio data corresponding the general purpose data can be multiplexed and recorded with the picture data even it has been imaged and recorded in the high-speed imaging mode, and pictures with audio can be played back based on the recorded data. Consequently, hereinafter, audio recording executed with picture recording in the high-speed imaging mode and respective operations of playback of the recorded data will be explained.

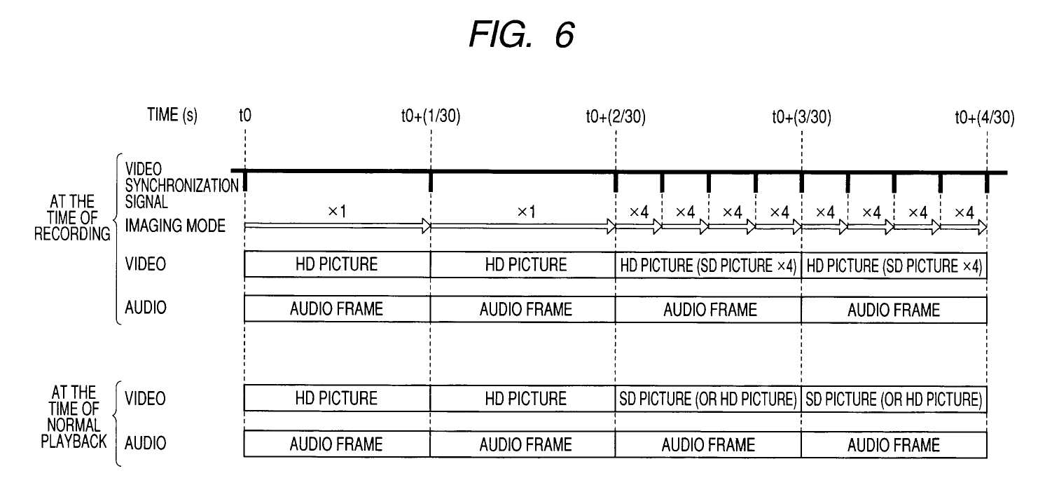

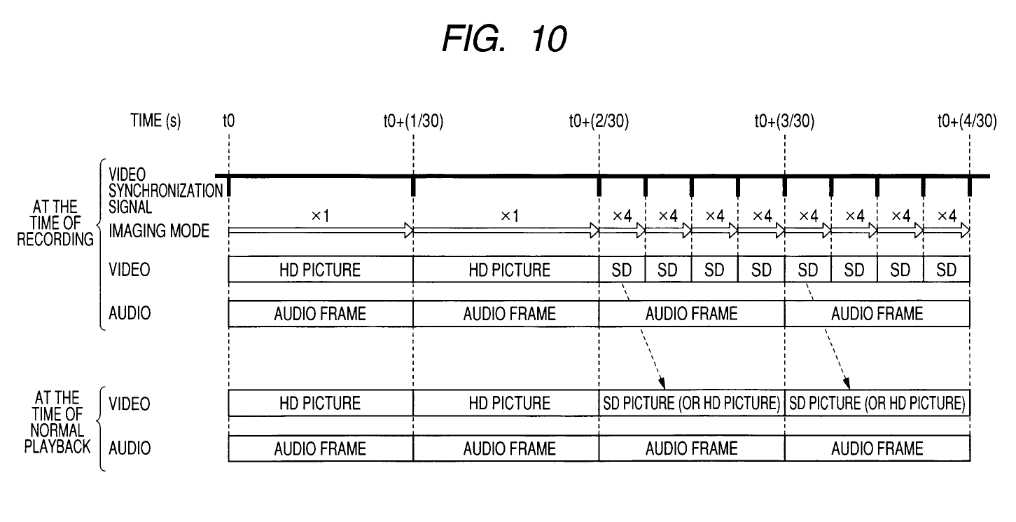

FIG. 6 is a timing chart schematically showing operations at the time of recording/playing back of pictures and audio in the first embodiment. In FIG. 6, a case in which the normal imaging mode and the high-speed imaging mode are continuously switched during recording of pictures is shown as an example, however, a specification in which it is difficult to switch respective mode during recording pictures may be applied in actual (the same applies to later described FIG. 10).

In FIG. 6, a period from a time to until 2/30 seconds has passed is the normal imaging mode, in which pictures are imaged at 30 fps in the imaging device 12 and HD pictures obtained by the imaging are encoded to generate a video ES. At the same time, audio data is recorded at a predetermined sampling rate to generate an audio ES from the audio CODEC 21. In the MUX/DEMUX 25, the audio ES is multiplexed with the video ES in an audio frame unit corresponding to one frame of the video ES, and a generated PS is recorded in the recording device 26.

In FIG. 6, a period from a time t0+(2/30) is the high-speed imaging mode, and pictures are imaged at 120 fps which is four times the standard in the imaging device 12. However, as described above, after imaged pictures of the high-speed screen rate are converted into the SD pictures, and four SD pictures are incorporated in the HD picture and transmitted in the internal circuits as the HD picture of 30 fps. Therefore, audio data is encoded by the same processing as the normal imaging mode, and an audio ES is multiplexed in the MUX/DEMUX 25 as the audio frame unit by the same processing as the normal imaging mode with respect to the video ES of the HD picture in which four SD pictures are incorporated. Accordingly, the stream data (PS) which is the same general-purpose format as the normal imaging mode is recorded in the recording device 26.

At the lower part of FIG. 6, operation when the PS recorded as the above is played back is schematically shown. When the PS recorded in the normal imaging mode is played back, the HD picture is decoded from the video ES separated in the MUX/DEMUX 25 and displayed. At the same time, the audio frame corresponding to one frame of the video ES is separated in the the MUX/DEMUX 25 and decoded in the audio CODEC 21, and the HD picture and audio are synchronously played back along the passing of time when the pictures were imaged.

On the other hand, when the PS recorded in the high-speed imaging mode is played back, operation of the picture data in which the video ES is separated in the MUX/DEMUX 25 and decoded in the video CODEC 15 is exactly the same as the operation of the normal imaging mode. As described above, only an area of one SD picture is cut from the decoded HD picture by the picture cutting unit 14a, and the SD picture is displayed. However, the speed of the displayed picture is maintained at 30 fps, therefore, the audio data can be played back and outputted synchronized with the displayed SD picture by processing in the same manner as the normal imaging mode.

When the PS recorded in the high-speed imaging mode is played back in the slow playback mode, switching speed of pictures to be displayed is different from the passing of time when the pictures were imaged, therefore, it is usually difficult to play back audio.

As described above, picture data recorded at the high-speed imaging mode can be played back by other playback devices corresponding to the same HD picture format, therefore, even in the case of stream data in which audio data is recorded at the same time, audio can be played back, synchronized with the playback of the HD picture. In this case, audio is played back along the same passing of time when the pictures were imaged, being synchronized with the HD picture of 30 fps in which four SD pictures are arrayed.

As described above, according to the imaging apparatus of the embodiment, the slow playback can be executed using picture data recorded at the high-speed imaging mode, and when the picture data is played back at the normal playback mode, playback can be executed with audio. Also when the picture data is played back by other general-purpose playback devices, it is certified that the data can be played back with audio.

### Second Embodiment

In the above first embodiment, playback compatibility of the recorded picture data is ensured by recording picture data as the HD picture of 30 fps in the high-speed imaging mode. Whereas in a second embodiment, picture data recorded at the high-speed imaging mode is recorded as the picture of 120 fps which is the same screen rate as at the time of imaging.

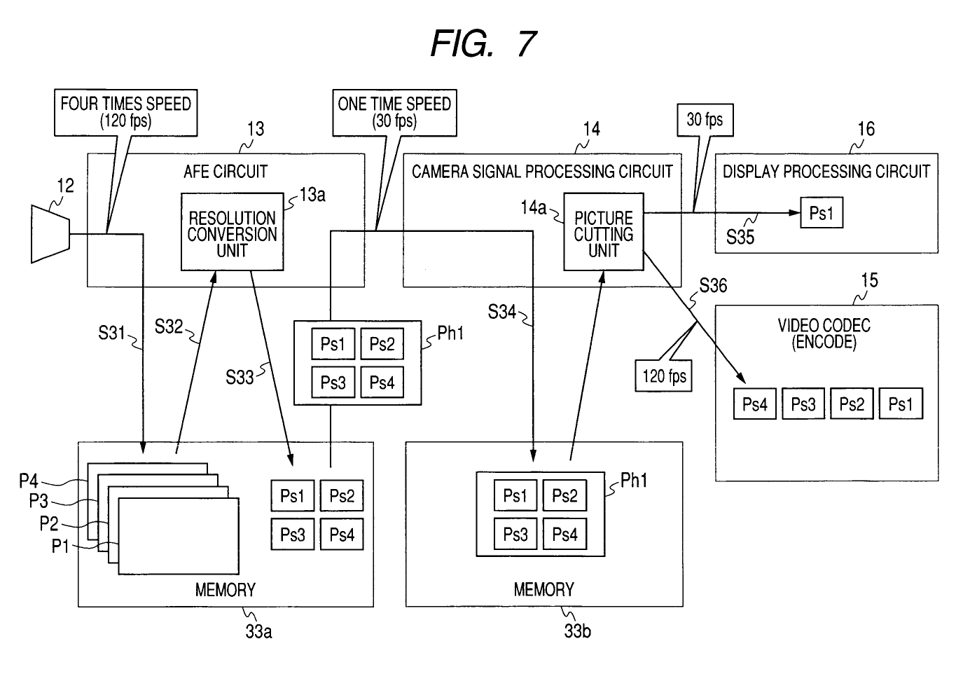

FIG. 7 is a diagram for explaining the flow of signals at the time of recording pictures in the second embodiment.

In FIG. 7, processes from the imaging device 12 images pictures of at 120 fps, the pictures are converted into SD pictures, four SD pictures are incorporated in one HD picture, until the picture quality correction is performed at the camera signal processing circuit 14 (Step S31 to Step S34) are the same as the processes (Step S1 to S4) of the first embodiment in FIG. 3.

Next, the picture cutting unit 14a reads the HD picture in which four SD pictures are incorporated from the memory region 33b, then, cuts respective areas of SD pictures from the HD picture. After that, one of the cut SD pictures (for example, the head SD picture such as the SD picture Ps1 in the drawing) is supplied to the display processing circuit 16 as a representative picture (Step S35). Accordingly, the representative picture is displayed at the LCD 17 at 30 fps in the same manner as the first embodiment.

When recording of the imaged pictures in the recording device 26 is requested, the picture cutting unit 14a supplies four SD pictures cut from the HD picture read from the memory region 33b (corresponding to SD pictures Ps1 to Ps4 in the drawing) sequentially to the video CODEC 15 (Step S36). Here, when the HD picture is read out from the memory region 33b at 30 fps, the four SD pictures cut from the HD picture can be transferred to the video CODEC 15 at 120 fps which is four-times speed without changing processing speed.

The video CODEC 15 encodes the transferred SD pictures at 120 fps to generate a video ES. At this time, the video ES by the SD picture at 120 fps is generated by adding, for example, playback time management information (PTS: Presentation Time Stamp) at an interval of 1/120 second with respect to picture data of each frame. The generated video ES is multiplexed with the audio ES in the MUX/DEMUX 25 and recorded in the recording device 26 as stream data (PS).

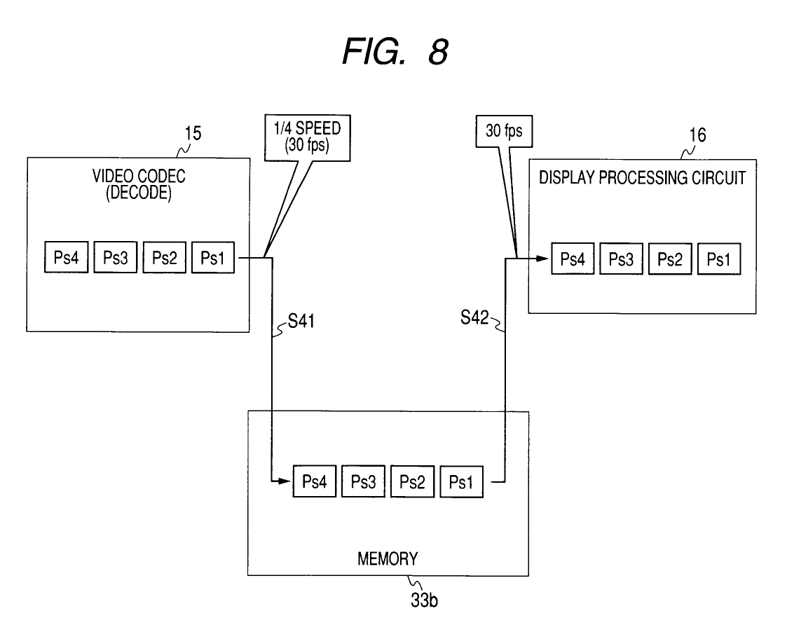

FIG. 8 is a diagram showing the flow of signals in the slow playback mode in the second embodiment.

In the slow playback mode, the above data of SD pictures at 120 fps is read out from the recording device 26 at ¼ speed with respect to the prescribed screen rate (namely, 30 fps). The operation is the same operation as in the case that the SD picture of 30 fps is normally read out.

The read-out data of SD pictures is decoded at the video CODEC 15 while maintaining the speed, and temporarily stored in the memory 33b (Step S41). In the decoding processing, each frame is decoded for a period of time four times the prescribed screen rate (namely, 120 fps). Accordingly, it is necessary that the video CODEC 15 newly includes a function of, for example, converting the PTS extracted from the video ES into information at time intervals of four times the prescribed rate.

The data of SD pictures decoded at the video CODEC 15 is stored in the memory region 33b at 30 fps, then, read out at the same 30 fps to be sequentially supplied to the display processing circuit 16 (Step S42). Accordingly, pictures of SD picture quality are sequentially displayed at 30 fps at the LCD 17 which receives picture signals from the display processing circuit 16 in the same manner as the first embodiment At this time, the switching cycle of the display screen becomes four times the cycle at the time of imaging, therefore, slow playback at ¼ speed can be realized.

As described above FIG. 7 and FIG. 8, it is necessary that the video CODEC 15 used in the embodiment is capable of executing encoding with respect to SD pictures at 120 fps and decoding of SD pictures supplied at ¼ speed. However, the video CODEC 15 is originally capable of encoding the HD picture of 30 fps, therefore, it is possible that the SD picture whose data amount is ¼ or less of the data amount of the HD picture is processed at 120 fps which is four times the SD picture by using a processing clock of the same speed as at the time of encoding. Therefore, it is not conceivable that power consumption particularly increases when, for example, encoding the SD picture of 120 fps, and it is relatively easy to newly develop an encoder having such function. And further, concerning decoding of the SD picture at ¼ speed, it is not necessary to increase processing ability though it is necessary to add control functions such as converting the PTS, therefore, it is relatively easy to newly develop a decoder having such function.

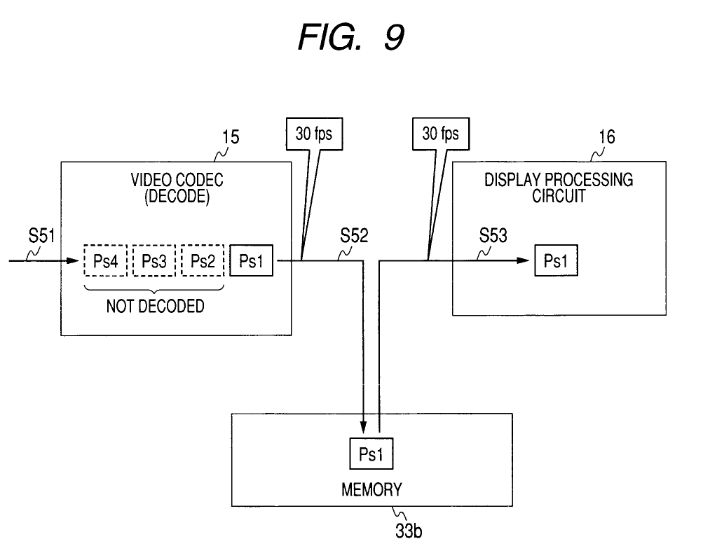

FIG. 9 is a diagram showing the flow of signals in the normal playback mode in the second embodiment.

In the normal playback mode, data of SD pictures of 120 fps recorded in the recording device 26 as described above is normally read out (namely, 120 fps) and supplied to the video CODEC 15 (Step S51). A read-out data amount per unit time at this time is less than the data amount when reading the standard HD picture (namely, 30 fps), therefore, the read-out operation can be executed at the same processing speed as the normal read-out operation of the HD picture of 30 fps. Therefore, such read-out operation can be executed by utilizing the existing signal transmission system almost as it is.

The video CODEC 15 decodes only data of one of four inputted SD pictures of 120 fps (for example, the head SD picture such as the SD picture Ps1 in the drawing) as a representative picture, and temporarily stores it in the memory region 33b (Step S52). At this time, data other than the representative picture is abandoned.

Next, the representative SD picture stored in the memory region 33b is supplied to the display processing circuit 16 at 30 fps (Step S53). As a result, only one of four imaged pictures is intermittently displayed in the LCD 17 as the representative picture, the picture display cycle at the time is along the passing of time when the pictures were imaged in the same manner as the first embodiment, therefore, the user can view the SD picture as a playback picture of normal speed.

For the operation of FIG. 9, it is necessary that the video CODEC 15 has a function of intermittently decoding the SD picture of 120 fps. However, the processing is substantially the same as the case in which the SD picture is decoded at 30 fps, therefore, it is relatively easy to realize a decoder having such function.

In the case that the PTS at intervals of 1/120 second is added at each frame at the read-out video ES, when the PTS of all frames are read out and the playback time is controlled in each time of decoding in the video CODEC 15, only frames having the PTS corresponding to the playback time at 30 fps are automatically decoded, therefore, the above operation can be realized without particularly changing the above operation. Consequently, such picture data can be played back as the SD picture of 30 fps without any problem in other playback devices including the decoder having the same specification, and compatibility of recorded data can be maintained within the range. When played back as described above, the SD picture which has been originally taken as one picture is played back and displayed as it is, which is different from the first embodiment, therefore, the user can view the playback picture without having sense of incongruity.

As described above, since pictures of 30 fps are outputted in the normal playback mode according to the embodiment in the same manner as the first embodiment, when audio data is multiplexed and recorded with the picture data in the high-speed imaging mode, pictures can be played back with audio.

FIG. 10 is a timing chart schematically showing operation at the time of recording/playback of pictures and audio in the second embodiment.

As described above, in the high-speed imaging mode, the SD pictures of 120 fps which are synchronized with the screen rate in the imaging device 12 are encoded and a video ES is generated. At this time, audio data is encoded by the same processing procedure as the normal imaging mode, and the PTS is added to each audio ES of the encoded audio data so as to synchronize with one of the continuous four SD pictures (for example, the head picture). Then, the video ES and the audio ES are multiplexed to be recorded in the recording device 26 as the PS.

When such picture data is played back in the normal playback mode, the SD pictures are read out from the recording device 26 at 120 fps, and only one of four SD pictures is decoded. At this time, the SD picture is substantially decoded at 30 fps, and pictures and audio are played back and outputted in the same manner as at the time of playing back pictures and audio recorded at the normal imaging mode by decoding the audio data (audio frame), synchronizing with the SD picture.

In addition, when the PS recorded at the high-speed imaging mode is played back by another playback device including a video decoder having the specification of controlling playback time based on the PTS of all frames, the SD picture of 30 fps can be played back and outputted with audio in the same manner as at the time of playback in the normal playback mode in the imaging apparatus.

As described above, also in the imaging apparatus according to the second embodiment, the slow playback can be executed by using picture data recorded in the high-speed imaging mode, and when the picture data is played back by the normal playback mode, the data can be played back with audio. In addition, when the picture data is played back by other general-purpose playback devices, the data can be played back with audio as the normal SD picture, depending on the specification of the decoder of the playback device. At this time, not the picture in which plural pictures are arrayed as in the first embodiment but the SD picture which has been originally imaged as one piece of picture is displayed as it is, that is, the picture which is the same as the SD picture normally recorded is can be displayed. The above function can be realized just by making a small modification to the existing circuit configuration, and it is possible to suppress the increase of manufacturing costs and enlargement of the apparatus size as compared with existing imaging apparatuses as much as possible.

Also in the second embodiment, continuous recording time of pictures imaged in the high-speed imaging mode is limited only by capacity of the recording device in the same manner as the first embodiment.

Also in the second embodiment, it is difficult to play back audio data normally in the slow playback mode in the same manner as in the first embodiment, therefore, audio is not played back in the slow playback mode.

In the above embodiments, four SD pictures obtained by imaging at the screen rate of four times the standard are incorporated in one HD picture, and the HD picture is transmitted inside the imaging apparatus. For example, when pictures are imaged at three times or double the standard in the imaging device 12, the pictures are converted into three, or two SD pictures respectively and incorporated in one HD picture to be transmitted, which can be processed in the same manner. That is, it is possible to perform slow playback of the picture data thus recorded at ⅓ speed or ½ speed, respectively.

When carrying out the invention, in the case that the screen rate (time resolution) at the time of imaging is made to be n-times the standard, pictures obtained by that are converted into pictures having spatial resolution of 1/n of the standard, and continuous n-pieces of pictures are incorporated in the picture having the standard size, it is possible to change the value of “n” optionally according to the spatial resolution of the picture requested at the time of playback. However, it is preferable to set “n” so that n-pieces of continuous pictures can be arranged without changing spatial arrangement of pixels in the picture of the standard size.

In the respective embodiments, the example in which the invention is applied to the imaging apparatus which records the imaged/picked up pictures and audio in the recording medium is shown, however, it is also preferable to apply the invention to devices in which a data stream is generated by encoding signals of pictures and audio to be transmitted to external devices through networks.

In addition, pictures and audio to be encoded are not limited to ones which have been imaged/picked up but, for example, signals of broadcast contents received by a TV tuner or signals inputted through digital or analog picture/audio input terminals are preferable. That is to say, the invention can be applied to devices which generate the data stream by receiving input of picture signals which can switch plural screen rates and encoding these signals.

It should be understood by those skilled in the art that various modifications, combinations, sub-combinations and alterations may occur depending on design requirements and other factors insofar as they are within the scope of the appended claims or the equivalents thereof.

What is claimed is:

1. A picture processing apparatus which processes picture signals, comprising:
a picture conversion unit converting pictures inputted at a high-speed screen rate into a picture in which n-pieces (“n” is an integer of 2 or more) of continuous inputted pictures are arranged in one screen and outputting the converted picture at a low speed screen rate which is 1/n of the high-speed screen rate;
a display picture cutting unit cutting one of n-pieces of inputted pictures from the picture outputted from the picture conversion unit and outputting the picture at the low-speed screen rate; and
a display processing unit generating picture signals for displaying the picture outputted from the display picture cutting unit at a display device.

2. An imaging apparatus which images pictures using a solid-state imaging device, comprising:
a picture conversion unit converting pictures imaged at a high-speed screen rate by the solid-state imaging device into a picture in which n-pieces (“n” is an integer of 2 or more) of continuous imaged pictures are arranged in one screen and outputting the converted picture at a low-speed screen rate which is 1/n of the high-speed screen rate,
a signal processing unit performing predetermined picture-quality compensation processing to the picture from the picture conversion unit,
a display picture cutting unit cutting one of n-pieces of imaged pictures from the picture processed by the signal processing unit and outputting the picture at the low-speed screen rate, and
a display processing unit generating picture signals for displaying the picture outputted from the display picture cutting unit at a display device.

3. The imaging apparatus according to claim 2, further comprising:
a picture encoding unit compressing and encoding data of the picture processed by the signal processing unit as picture data of the low-speed screen rate; and
a recording unit recording the encoded picture data from the picture encoding unit in a recording medium.

4. The imaging apparatus according to claim 3, further comprising:
a picture decoding unit reading out the encoded picture data recorded in the recording medium and decompressing and decoding the data at a screen date which is 1/n of the low-speed screen rate, and
wherein the display picture cutting unit sequentially cut the n-pieces of imaged pictures from pictures decoded at the picture decoding unit and outputting the pictures to the display processing unit at the low-speed screen rate.

5. The imaging apparatus according to claim 4, wherein the picture decoding unit further includes a
function of reading out the encoded picture data recorded in the recording medium and decompressing and decoding the data at the low-speed screen rate, and
wherein the display picture cutting unit cuts one of the n-pieces of imaged pictures from pictures decoded at the low-speed screen rate in the picture decoding unit, and outputting it to the display processing unit at the low-speed screen rate.

6. The imaging apparatus according to claim 3, further comprising:
an audio pick-up unit picking up audio; and
an audio encoding unit compressing and encoding audio data picked up by the audio pick-up unit, and
wherein the recording unit records multiplexed data in the recording medium, in which the encoded picture data from the picture encoding unit and the encoded audio data from the audio encoding unit are multiplexed.

7. The imaging apparatus according to claim 6, further comprising:
a picture decoding unit including a function of reading out multiplexed data recorded in the recording medium and decompressing and decoding the encoded picture data in the multiplexed data at a screen rate which is 1/n of the low-speed screen rate, and a function of decompressing and decoding the encoded picture data in the read-out multiplexed data at the low-speed screen rate; and
an audio decoding unit decompressing and decoding the encoded audio data in the multiplexed data at the same processing speed as the speed at the time of recording only when the decoding processing is executed by the picture decoding unit at the low-speed screen rate, and
wherein, when decoding at the screen rate which is 1/n of the low-speed screen rate is executed by the picture decoding unit, the display picture cutting unit sequentially cut n-pieces imaged pictures from the decoded pictures and outputted them to the display processing unit at the low-speed screen rate, and
wherein, when the decoding at the low-speed screen rate is executed by the picture decoding unit, the display picture cutting unit cut one of the n-pieces imaged pictures from the decoded pictures and output it to the display processing unit at the low-speed screen rate.

8. The imaging apparatus according to claim 2, further comprising:
a recorded picture cutting unit sequentially cutting n-pieces of imaged pictures from pictures processed in the signal processing unit and outputting them at the high-speed screen rate;
a picture encoding unit compressing and encoding data of the imaged pictures outputted from the recorded picture cutting unit as picture data of the high-speed screen rate; and
a recording unit recording encoded picture data from the picture encoding unit in a recording medium.

9. The imaging apparatus according to claim 8, further comprising:
a picture decoding unit reading out the encoded picture data recorded in the recording medium, decompressing and decoding the data at the low-speed screen rate to be outputted to the display processing unit.

10. The imaging apparatus according to claim 9,
wherein the picture decoding unit further include a function of reading out the encoded picture data recorded in the recording medium, decompressing and decoding one of the continuous n-pieces of encoded picture data intermittently at the low-speed screen rate to be outputted to the display processing unit.

11. The imaging apparatus according to claim 8, further comprising:
an audio pick-up unit picking up audio; and
an audio encoding unit compressing and encoding audio data picked up by the audio pick-up unit, and
wherein the recording unit records multiplexed data in the recording medium, in which the encoded picture data from the picture encoding unit and the encoded audio data from the audio encoding unit are multiplexed.

12. The imaging apparatus according to claim 11, further comprising:
a picture decoding unit including a function of reading out multiplexed data recorded in the recording medium, decompressing and decoding the data at the low-speed screen rate to be outputted to the display processing unit, and a function of decompressing and decoding one of the continuous n-pieces of encoded picture data in the read-out multiplexed data intermittently at the low-speed screen rate to be outputted to the display processing unit; and
an audio decoding unit decompressing and decoding the encoded audio data in the multiplexed data at the same processing speed as at the time of recording only when the processing of decoding one of the n-pieces of encoded picture data at the low-speed screen rate is executed by the picture decoding unit.

13. The imaging apparatus according to claim 8,
wherein the picture encoding unit receives a picture having resolution capable of arranging n-pieces of the imaged pictures and compressing and encoding the picture at the low-speed screen rate.

14. The imaging apparatus according to claim 2, further comprising:
a resolution conversion unit converting resolution of pictures imaged at the high-speed screen rate by the solid-state imaging device into 1/n or less of resolution of pictures outputted from the picture conversion unit, and outputting the converted pictures to the picture conversion unit.

15. The imaging apparatus according to claim 14,
wherein the solid-state imaging device further includes a function of imaging pictures at the low-speed screen rate, and
wherein the resolution conversion unit further includes a function of converting resolution of pictures imaged at the low-speed screen rate by the solid-state imaging device into resolution of pictures outputted from the picture conversion unit, and outputting the converted pictures to the signal processing unit.

16. A picture processing method which processing picture signals, comprising the steps of:
converting pictures inputted at a high-speed screen rate into a picture in which continuous n-pieces (“n” is an integer of 2 or more) inputted pictures are arranged in one screen and outputting the converted picture at a low-speed screen rate which is 1/n of the high-speed screen rate by a picture conversion unit,
cutting one of the n-pieces inputted pictures from the picture outputted from the picture conversion unit and outputting it at the low-speed screen rate by a display picture cutting unit; and
generating picture signals for displaying the picture outputted from the display picture cutting unit at a display device by a display processing unit.

17. The imaging method for imaging pictures by using a solid-state imaging device, comprising the steps of:
converting pictures imaged at a high-speed screen rate by the solid-state imaging device into a picture in which the continuous n-pieces (“n” is an integer of 2 or more) of imaged pictures are arranged in one screen and outputting the converted picture at a low-speed screen rate which is 1/n of the high-speed screen rate by a picture conversion unit;
performing predetermined picture-quality compensation processing to the picture from the picture conversion unit by a signal processing unit;
cutting one of n-pieces of imaged pictures from the picture processed by the signal processing unit and outputting it at the low-speed screen rate by a display picture cutting unit; and
generating picture signals for displaying the picture outputted from the display picture cutting unit at a display device by the display processing unit.
